(19) United States
(12) Patent Application Publication
(10) Pub. No.: US 2008/0254350 A1
(43) Pub. Date: Oct. 16, 2008

(54) Battery pack

(76) Inventor: Deayon Moon, Yongin-si (KR)

Correspondence Address: ROBERT E. BUSHNELL, 1522 K STREET NW, SUITE 300, WASHINGTON, DC, 20005-1202, US

(21) Appl. No.: 12/081,212

(22) Filed: Apr. 11, 2008

(30) Foreign Application Priority Data
Apr. 11, 2007 (KR) 10-2007-0035715

(51) Int. Cl. H01M 2/10

(52) U.S. Cl. 429/98; 429/100

(57) ABSTRACT

Disclosed is a battery pack having a case in which a groove is formed near a pin point gate part so as to prevent formation of a crack in the case caused by external impact. The groove distributes stress caused by external impact. By preventing the formation of a crack, an electrolyte leaking out of a bare cell is prevented from flowing into a notebook computer through the crack. The battery pack includes at least one bare cell, a circuit board electrically coupled to the bare cell and a case formed so as to receive the bare cell and the circuit board. The case includes pin point gates formed in the front of the case during an injection molding process and grooves formed near the pin point gates.

### CLAIM OF PRIORITY

This application makes reference to, incorporates the same herein, and claims all benefits accruing under 35 U.S.C. §119 from an application earlier filed in the Korean Intellectual Property Office on the 11^{th} of Apr. 2007 and there duly assigned Serial No. 10-2007-0035715.

### BACKGROUND OF THE INVENTION

1. Field of the Invention

The present invention relates to a battery pack and more particularly, to a battery pack including a case that has a pin point gate part and a groove formed near the pin point gate part. The groove prevents formation of a crack around the pin point gate part by distributing stress applied on the pin point gate part by external impact.

2. Description of the Related Art

Recently, portable electronic devices such as a cellular phone, PDA (Personal Digital Assistants), a camcorder, a notebook computer have been broadly used. These devices have a built-in battery pack so as to operate in the place where an additional power supply is not provided.

Generally, the battery pack uses a chargeable/dischargeable secondary battery because of its low cost. The secondary batteries include a nickel-cadmium (Ni—Cd) battery, a nickel-hydride (Ni-MH) battery, a lithium (Li) battery, a lithium-ion (Li-ion) battery and a lithium polymer battery.

The battery pack may be classified into a core pack in which a protection circuit has been installed in a chargeable/dischargeable bare cell, a soft pack in which tubing has been performed after the protection circuit have been installed in a bare cell, and a hard pack which has been finished by a hard case after the protection circuit have been installed in the bare cell.

The bare cell means a battery itself in which additional elements such as the protection circuit and the like are not installed. The bare cell is classified into a prismatic type, a pouch type and a cylindrical type. A plurality of cylindrical type bare cells is generally used for a high capacity of battery pack like a notebook computer. The plurality of the cylindrical type bare cells for the high capacity is installed with coupled to each other electrically in series and/or parallel, and installed in the battery pack for the notebook. Further, a separator plate of a finite width is provided on the bare cells coupled in series and/or parallel, and a circuit board provided with the protection circuit is located on the separator plate. In addition, the circuit board and the bare cells are electrically coupled by a plurality of wires. Herein, the separator plate insulates the circuit board from the bare cells and simultaneously supports the circuit board.

However, the battery pack has a problem that brittle deformation such as a crack firstly occurs at a pin point gate part because a surface of the pin point gate part located at an end of a rib is not even compared to a peripheral part, and thus stress is concentrated on the pin point gate part when an impact load is applied to a case.

When the brittle deformation occurs in the case of the battery pack by impact load, there is a problem that an electrolyte leaking out of the bare cell flows along the surface of the case, and eventually flows into inside a notebook computer, thereby damaging the notebook computer, and causing an electrical short.

Further, a separator plate is located on a lower face of the circuit board, and accordingly the electrolyte flowed toward the circuit board does not move to other place, and remains in the circuit board for a long time, thereby allowing damage of the notebook and an electrical short to be accelerated. Furthermore, there is another problem that the charge/discharge control may not be well performed because of the damage of the circuit board, and fire may be broken out due to an electrical spark.

### SUMMARY OF THE INVENTION

Accordingly, an object of the present invention is to provide a battery pack that can prevent formation of crack on a case that accommodate bare cells by forming grooves near a pin point gate part so as to distribute stress caused by external impact, and that can prevent an electrolyte leaking out of a bare cell from flowing into a notebook computer through the case.

According to another object of the present invention, there is to provide a battery pack that can prevent an electrolyte leaking out of a bare cell from flowing into a notebook computer through the case by preventing formation of crack in the case.

Additional advantages, objects and features of the invention will be set forth in part in the description which follows, and in part will become apparent to those having ordinary skill in the art upon examination of the following or may be learned from practice of the invention.

According to an aspect of the present invention, there is provided a battery pack which includes at least one bare cell, a circuit board electrically coupled to the bare cell, and a case accommodating the bare cell and the circuit board. The case has a first end wall, a second end wall, and a side wall connecting the first end wall to the second end wall. The side wall including a pin point gate, and a groove formed at a predetermined distance from the pin point gate.

The grooves may be formed in a V-shape. The groove may be located within 10 mm from the pin point gate along a direction extending from the first end wall to the second end wall. The groove may be being cut from an edge of the side wall.

The side wall may further include another groove formed at another predetermined distance from the pin point gate. A distance between the groove and the another groove may be within 20 mm. The another groove may be located within 10 mm from the pin point gate along a direction extending from the first end wall to the second end wall. The pin point gate may be located between the groove and the another groove.

The battery pack may further comprise a separator plate that is located between the bare cell and the circuit board. The separator plate supports the circuit board. The separator plate may include a flat surface part that is substantially parallel to the circuit board, and a curved surface part that surrounds a portion of the bare cell. The flat surface part of the separator plate may comprise a plurality of discharge holes through which an electrolyte leak over the separator plate flows back toward the bare cell.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a perspective view illustrating a case of a battery pack;

FIG. 2 is a perspective view illustrating a battery pack, which can be installed in a notebook computer, constructed according to the principles of one exemplary embodiment of the present invention;

FIG. 3 is a perspective view illustrating a battery cell of the battery pack of the exemplary embodiment of the present invention;

FIG. 4 is a perspective view illustrating a case and a cover of the battery pack constructed as the exemplary embodiment of the present invention;

FIG. 5 is an enlarged perspective view illustrating the ‘A’ portion shown in FIG. 4;

FIG. 6 is a perspective view illustrating a case and a cover of the battery pack constructed as another exemplary embodiment of the present invention; and

FIG. 7 is an enlarged perspective view illustrating the ‘B’ portion shown in FIG. 6.

### DETAILED DESCRIPTION OF THE INVENTION

Hereinafter, preferred embodiments of the present invention will be described in detail with reference to the accompanying drawing. The aspects and features of the present invention and methods for achieving the aspects and features will be apparent by referring to the embodiments to be described in detail with reference to the accompanying drawings. However, the present invention is not limited to the embodiments disclosed hereinafter, but can be implemented in diverse forms. The matters defined in the description, such as the detailed construction and elements, are nothing but specific details provided to assist those of ordinary skill in the art in a comprehensive understanding of the invention, and the present invention is only defined within the scope of the appended claims. In the entire description of the present invention, the same drawing reference numerals are used for the same elements across various figures.

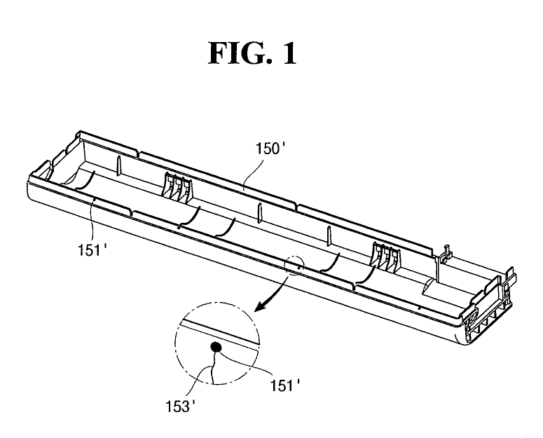

FIG. 1 is a perspective view illustrating a case of a battery pack. It is shown that a crack 153′ is produced near a pin point gate part 151′ in a case 150′.

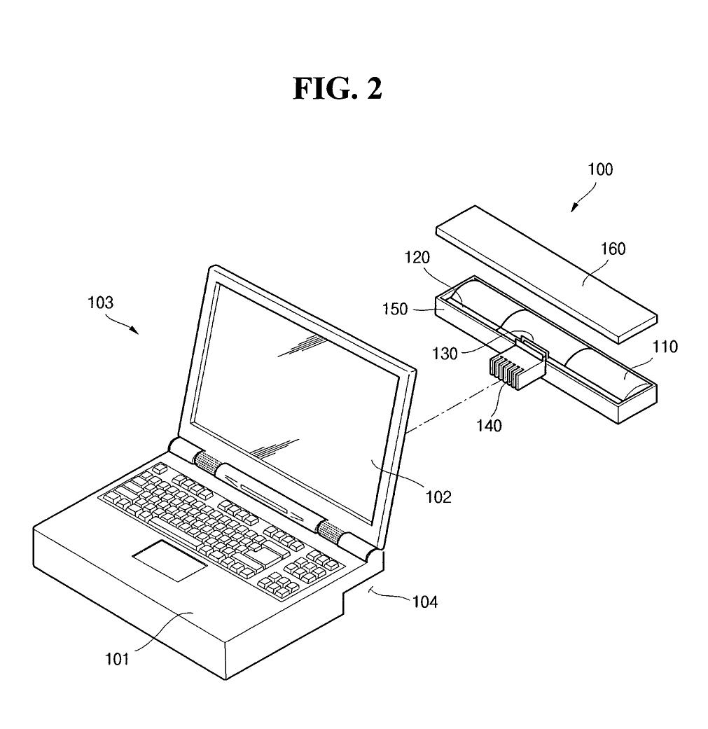

FIG. 2 is a perspective view illustrating a battery pack, which can be installed in a notebook computer, constructed as one exemplary embodiment of the present invention. Referring to FIG. 2, a battery pack 100 is detachably mounted in a fixing part 104 formed on a back of a main body 101 of a notebook computer 103, which includes the main body 101 and a display part 102. The fixing part 104 is provided with an opening having predetermined space on the back of the main body 101 so that the battery pack 100 is electrically and mechanically detachably mounted in the fixing part 104.

On the other hand, the battery pack 100 includes at least one battery cell 110, a circuit board 120 electrically connected to the battery cell 110, a flexible line film 130 electrically connected to the circuit board 120, a connector 140 electrically coupled to the flexible line film 130 so as to be again electrically coupled to the main body 101, a case 150 that receives the battery cell 110, the circuit board 120, the flexible line film 130, and the connector 140, and a cover 160 that combines with the case 150.

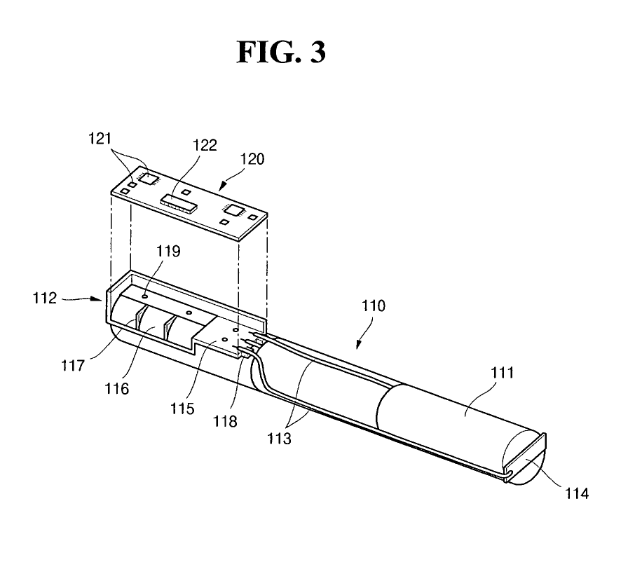

FIG. 3 is a perspective view illustrating a battery cell of the battery pack of the exemplary embodiment of the present invention. Referring to FIG. 3, the battery cell 110 of the battery pack 100 includes at least one bare cell 111, a separator plate 112 located on an upper surface of the bare cell 111. On the separator plate 112, a circuit board 120 electrically coupled to the bare cell 111 through a wire 113 is located.

The bare cell 111 may be any one of a nickel-cadmium (Ni—Cd) battery, a nickel-hydride (Ni-MH) battery, a lithium (Li) battery, a lithium-ion (Li-ion) battery and a lithium polymer battery and the equivalents, but not limited thereto. Further, although the bare cell 111 is shown as a cylindrical type, it may be a prismatic type or a pouch type and the like. The plurality of bare cells may be connected in series and/or parallel, and the connecting member may be a lead plate 114. One end of the wire 113 is connected to the lead plate 114, and the other end of the wire 113 is connected to the circuit board 120.

The separator plate 112 may be located on any one of bare cells 111, if there is a plurality of bare cells. The separator plate 112 includes a substantially flat surface part 115 located on the bare cell 111, and a curved surface part 116 surrounding a portion of the bare cell 111. Therefore, the flat surface part 115 is located between a bare cell 111 and circuit board 120. A plurality of vertical plates 117 may be formed at the curved surface part 116. Each of the vertical plates 117 is disposed substantially perpendicular to the flat surface part 115, and has an upper side surface that is the same level as the flat surface part 115. Accordingly, the circuit board 120 is supported by the flat surface part 115 of the separator plate 112 and the upper side surfaces of the vertical plates 117. Further, a hook 118 is formed at the one end of the flat surface part 115 of the separator plate 112. The wire 113 is connected, fixed, and arranged to the hook 118 so as to be coupled to the lead plate 114 bonded to the bare cell 111, and to the circuit board 120. Accordingly, there is no need to attach the wire 113 to the separator plate 112 or the surface of the bare cell 111 using a tape or the like for fixing the wire 113. Furthermore, a plurality of discharge holes 119 are formed on the flat surface part 115 of the separator plate 112 so as to quickly discharge an electrolyte leak toward the bare cell 111 below the separator plate 112, whenever the electrolyte leaks to the upper part of the separator plate 112 or the circuit board 120.

The circuit board 120 fits to the upper face of the separator plate 112 as described above. That is, the circuit board 120 fits to the flat surface part 115 of the separator plate 112 and an upper side surface of the vertical plate 117. The circuit board 120 includes a protective circuit so as to prevent the bare cell 111 from being over-discharged or over-charged. The protective circuit includes a plurality of semiconductor devices 121 and connected to an external device through a connecting device 122 electrically coupled to the connector 140.

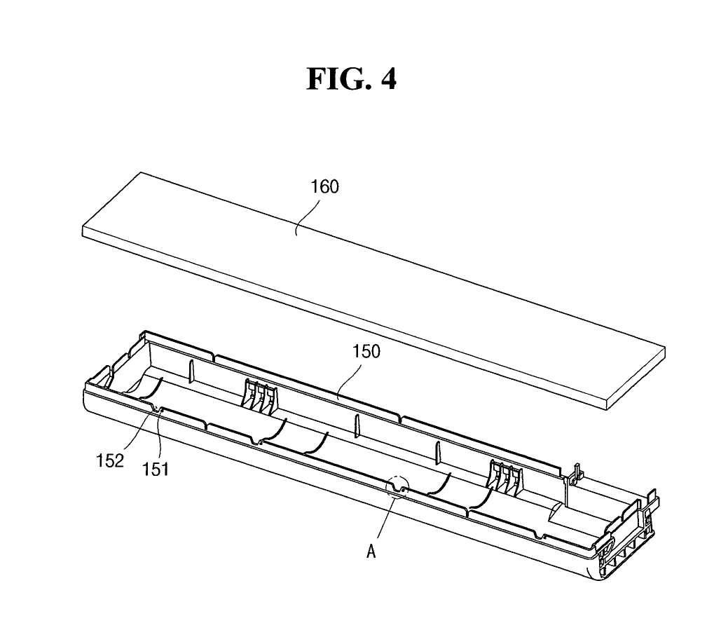

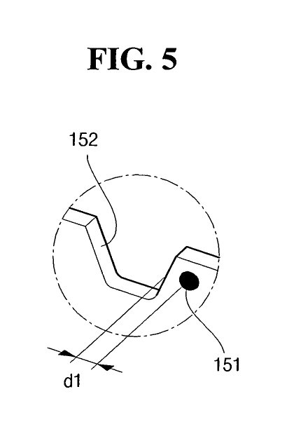

FIG. 4 is a perspective view illustrating a case and a cover of the battery pack according to one exemplary embodiment of the present invention, FIG. 5 is an enlarged perspective view illustrating the ‘A’ portion shown in FIG. 4. Referring to FIG. 4, a case 150 of the battery pack is formed in the shape that can receive the bare cell 111. Pin point gates 151 are formed in the front of the case through an injection molding process, and one of grooves 152 is formed near each of the pin point gates 151. The case 150 has a first end wall, a second end wall at an opposite end of the first end wall, and a side wall connecting the first end wall to the second end wall. The pin point gates 151 and the grooves 152 are formed on the side wall.

The pin point gate 151 is a type that a three-stage structure mold and can be applicable to a singular cavity mold or a plurality of cavities mold such as polystyrene (PS), polyethylene (PE), polypropylene (PP) may be applicable thereto. Because the gates can be formed at several places in case of a molded product with a large injection area, the molded product of the case has little deformation and remaining deformation are little near the gate. The pin point gate 151 formed on the surface of the molded product of the case is finished so as not to have any remarkable trace of the gate.

The groove 152 is formed near the pin point gate 151, and is formed preferably in V shape, but may be formed in other shape. If external impact is applied to the case 150, a stress can be induced on the surface of the case 150 by the external impact. The stress can be concentrated on the pin point gates 151. The groove 152 distributes stress applied to the pin point gate 151, and therefore prevents brittle deformation on the area around the pin point gates 151. Therefore, formation of a crack on or around the pin point gates 151 can be prevented. Herein, the closer the groove 152 is located to the pin point gate 151, the more advantageous it is to distribute the stress concentrated at the pin point gate 151 by the external impact. Accordingly, the groove 152 is spaced within 10 mm distance (d1) from the pin point gate 151 in a horizontal direction (along the edge of the side wall). Herein the distance between the groove 152 and the pin point gate 151 is measured from an edge of the groove 152 to about a center of the pin point gate 151. The horizontal direction means a direction extending from the first end wall to the second end wall. If, the groove 152 is spaced over 10 mm distance (d1) from the pin point gate 151 in a horizontal direction, then there is no effect that the stress concentrated at the pin point gate 151 by the external impact is distributed.

FIG. 5 shows that the groove 152 is formed by cutting the side wall from an edge of the side wall of the case 150. The groove 152, however, can be formed at a location being spaced apart from the edge of the side wall of the case, such as a middle portion of the side wall, depending on the location of the pin point gate 151. In this case, it is not necessary to form the groove from the edge of the side wall of the case 150, and can be formed as a cavity on the side wall. In this case, the groove can have a hollow V shape or U shape, having a cavity formed in V or U shape. In this case, the distance between the groove and the pin point gate is defined as a distance from a center of the pin point gate to an edge of the groove that is the closest edge to the pin point gate. Meanwhile, the groove 152 can be integrally formed with the case 150 by injection molding.

Further, although a crack is generated near the pin point gate 151 of the case 150 by an external impact, the groove 152 prevents the crack, which is generated firstly at the upper part of the pin point gate 151, from propagating below the pin point gate 151.

The case 150 constituted with above elements accommodates the battery cell 110, the circuit board 120, the flexible line film 130, and the connector 140, and then is coupled with the cover 160 to thereby form the battery pack 100.

Hereinafter, a case of a battery pack according to another embodiment of the present invention will be described. The battery pack according to another embodiment of the present invention has the same constitution as the battery pack according to the above embodiment of the present invention except for the case. Accordingly, the only case of the battery pack according to another embodiment of the present invention will be described below.

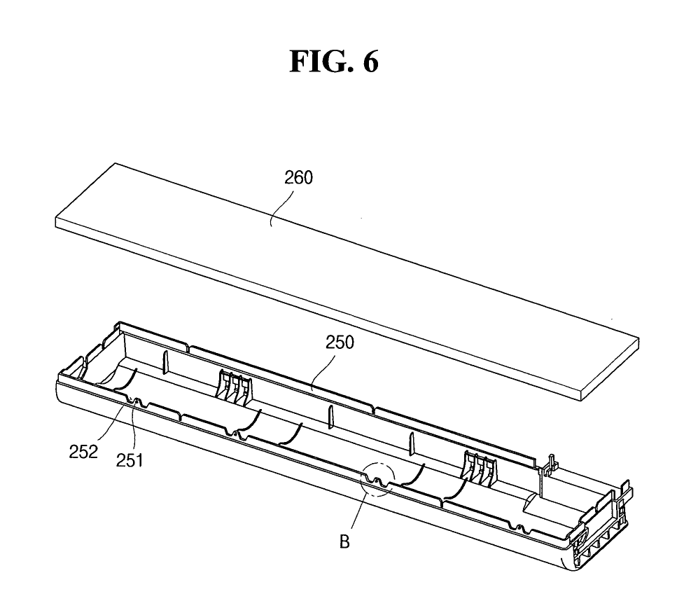

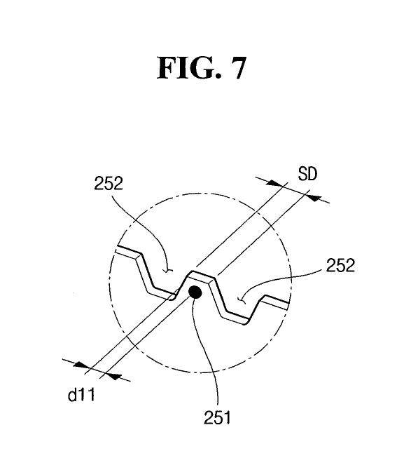

FIG. 6 is a perspective view illustrating a case and a cover of the battery pack constructed as another exemplary embodiment of the present invention, and FIG. 7 is an enlarged perspective view illustrating the ‘B’ portion shown in FIG. 6.

Referring to FIG. 6, a case 250 of the battery pack is formed in the shape that can receive the bare cell 111. Pin point gates 251 are formed in the front of the case through an injection molding process, and one of grooves 252 is formed near each of the pin point gates 251. The case 250 has a first end wall, a second end wall at an opposite end of the first end wall, and a side wall connecting the first end wall to the second end wall. The pin point gates 251 and the grooves 252 are formed on the side wall.

The pin point gate 251 is a type that a three-stage structure mold and can be applicable to a singular cavity mold or a plurality of cavities mold such as polystyrene (PS), polyethylene (PE), polypropylene (PP) may be applicable thereto. Because the gates can be formed at several places in case of a molded product with a large injection area, the molded product of the case has little deformation and remaining deformation are little near the gate. The pin point gate 251 formed on the surface of the molded product of the case is finished so as not to have any remarkable trace of the gate.

In this embodiment, at least two grooves are provided near the pin point gate 251 as shown in FIGS. 6 and 7. Each of the grooves 252 is formed near the pin point gate 251, and is formed preferably in V shape, but may be formed in other shape. If external impact is applied to the case 250, a stress can be induced on the surface of the case 250 by the external impact. The stress can be concentrated on the pin point gate 251. The grooves 252 distribute stress applied to the pin point gate 251, and therefore prevents brittle deformation on the area around the pin point gate 251. Therefore, formation of a crack on or around the pin point gate 251 can be prevented. Herein, at least two grooves 252 form a group, and the pin point gate 251 is formed between the grooves 252. A spaced distance (SD) between the two grooves 252 is within 20 mm, and one of the grooves 252 is spaced within 10 mm distance (D11) from the pin point gate 251 in a horizontal direction (along the edge of the side wall). This is to make the stress concentrated at the pin point gate 251 by the external impact to distribute to the grooves 252 located at both sides of the pin point gate 251. As described above, if the grooves 252 are formed at both sides of the pin point gate 251, then there is a great advantage to distribute the stress concentrated at the pin point gate 251 by the external impact. Herein the distance between the groove 152 and the pin point gate 151 is measured from an edge of the groove 252 to about a center of the pin point gate 151.

Further, although a crack is generated near the pin point gate 251 of the case 250 by an external impact, the grooves 252 prevent the crack, which is generated firstly at the upper part of the pin point gate 251, from propagating below the pin point gate 251.

The case 250 constituted with above elements accommodates the battery cell 110, the circuit board 120, the flexible line film 130, and the connector 140, and then is coupled with the cover 260 to thereby form the battery pack.

As described above, the battery pack of the present invention has the following advantages. First, the battery pack can protect the case by forming the grooves near the pin point gates so as to distribute the stress concentrated by external impact. Second, the battery pack can prevent the electrolyte leaking out of the bare cell from flowing into a notebook computer through the case by preventing formation of crack in the case.

It should be understood by those of ordinary skill in the art that various replacements, modifications and changes in the form and details may be made therein without departing from the spirit and scope of the present invention as defined by the following claims. Therefore, it is to be appreciated that the above described embodiments are for purposes of illustration only and are not to be construed as limitations of the invention.

What is claimed is:

1. A battery pack comprising:
at least one bare cell;
a circuit board electrically coupled to the bare cell; and
a case accommodating the bare cell and the circuit board, the case having a first end wall, a second end wall, and a side wall connecting the first end wall to the second end wall, the side wall including:
a pin point gate; and
a groove formed at a predetermined distance from the pin point gate.

2. The battery pack of claim 1, wherein the groove is formed in a V-shape.

3. The battery pack of claim 1, wherein the groove is located within 10 mm from the pin point gate along a direction extending from the first end wall to the second end wall.

4. The battery pack of claim 1, wherein the side wall further includes another groove formed at another predetermined distance from the pin point gate.

5. The battery pack of claim 4, wherein a distance between the groove and the another groove is no greater than 20 mm.

6. The battery of claim 5, wherein the another groove is located within 10 mm from the pin point gate along a direction extending from the first end wall to the second end wall.

7. The battery of claim 4, wherein the pin point gate is located between the groove and the another groove.

8. The battery of claim 1, wherein the groove is formed by cutting the side wall from an edge of the side wall.

9. The battery pack of claim 1, further comprising a separator plate that is located between the bare cell and the circuit board, the separator plate supporting the circuit board.

10. The battery pack of claim 9, wherein the separator plate includes a flat surface part that is substantially parallel to the circuit board, and a curved surface part that surrounds a portion of the bare cell.

11. The battery pack of claim 10, wherein the flat surface part of the separator plate comprises a plurality of discharge holes through which an electrolyte leak over the separator plate flows back toward the bare cell.
